(19) United States
(12) Patent Application Publication
(10) Pub. No.: US 2003/0176117 A1
(43) Pub. Date: Sep. 18, 2003

(54) Electrical unit with a connector for a loop thorough conductor

(76) Inventors: Wolfgang Brandl, Amberg (DE); Peter Donhauser, Amberg (DE); Alfred Fischer, Schwandorf (DE); Ludwig Niebler, Laaber (DE)

Correspondence Address: HARNESS, DICKEY & PIERCE, P.L.C., P.O.BOX 8910, RESTON, VA, 20195, US

(21) Appl. No.: 10/344,762

(22) PCT Filed: Aug. 3, 2001
(86) PCT No.: PCT/DE01/02973

(30) Foreign Application Priority Data
Aug. 16, 2000 (DE) 10039961.4

(51) Int. Cl. H01R 9/22

(52) U.S. Cl. 439/894

(57) ABSTRACT

The invention relates to an electrical unit comprising a mounting device (3, 4) for fastening the unit to a supporting element (2), e.g. to a mounting rail (2), and at least one insulation piercing connecting device (7) provided with an insulation piercing element (8) and with a holding element (9). The insulation piercing element (8) and holding element (9) can move in relation to one another. When the unit is fastened to the supporting element (2), a conductor (12) can be inserted into the holding element (9). This enables said conductor to be looped through the holding element (9). The conductor (12) can be clamped by transferring the insulation piercing element (8) and holding element (9) into a closed position.

The present invention relates to an electrical device with a mounting device for fastening the device to a supporting element, e.g. to a mounting rail.

Units of this kind are generally known, e.g. in the form of contactors, relays, circuit breakers, field bus devices and many others.

Furthermore, so-called insulation displacement terminals are generally known, by means of which conductors can be clamped without previously removing the conductor insulation.

A typical disadvantage of insulation displacement terminals is that they are relatively large and, as a rule, can accept only one single conductor end or two conductor ends. Therefore, when electrical units are provided with insulation displacement terminals, continuous wiring must either be dispensed with or a relatively large physical volume must be accepted, as two—already relatively large in their own right—insulation displacement terminal devices are necessary, namely one each for feeding in and feeding out the wiring. For this reason, the majority of electrical units even today are fitted with comparatively compact screw or spring terminals.

A cable connector for a ribbon cable is disclosed in U.S. Pat. No. 4,062,616, which has an insulation displacement terminal device, the insulation displacement terminal device having a large number of insulation displacement terminals and a holding element. The insulation displacement terminals and the holding element can move in relation to one another. A ribbon cable can be inserted into the insulation displacement terminal device in a relative open position of insulation displacement terminals and holding element and can be clamped by moving it to a closed position. The ribbon cable can be looped through the holding element.

A cable connector for electronic devices is disclosed in U.S. Pat. No. 4,950,169, which internally has an electrical circuit by means of which the pin configuration is determined. With this cable connector, the conductors are connected to the circuit by means of screw connections.

An electrical power connector is disclosed in U.S. Pat. No. 4,969,839. This connector has an insulation displacement terminal device, which has several insulation displacement terminals and a common holding element. The insulation displacement terminals and the holding element can move in relation to one another. Conductors inserted into the holding element can be clamped by relative movement of holding element and insulation displacement terminals. The holding element has laterally open insertion slots for the conductors.

A plug connector for electrical conductors is disclosed in EP 0 921 592 A2. This plug connector has an insulation displacement terminal device with an insulation displacement terminal and a holding element. The insulation displacement terminal and the holding element can move in relation to one another. A conductor can be inserted in a relative open position of the insulation displacement terminal and holding element and can be clamped by moving it to a closed position. The conductor can be looped through the holding element. For this purpose, the holding element has a laterally open, straight, continuous insertion slot for the holder.

The object of the present invention is to create an electrical device with which, in spite of the use of insulation displacement technology, through-wiring can be achieved while taking up relatively little space. At the same time, the capability for the conductor to loop through the holding element should be achievable in a simple manner.

For this purpose, the electrical device has the following features:

It has a mounting device for fastening the device to a supporting element, e.g. to a mounting rail.

It has at least one insulation displacement terminal device with an insulation displacement terminal and a holding element.

The insulation displacement terminal and the holding element can move in relation to one another.

When the device is fastened to the supporting element, a conductor can be inserted into the holding element in a relative open position of insulation displacement terminal and holding element and can be clamped by moving it to a closed position.

The holding element is designed in such a way that the conductor can be looped through the holding element.

The holding element has a laterally open, continuous insertion slot for the conductor.

The insertion slot has a curved section.

With the electrical device according to the invention, a conductor, which is simultaneously the infeed and outfeed conductor, can therefore be clamped in a single insulation displacement terminal on the mounted electrical unit.

The construction of the electrical device is particularly , simple if the insulation displacement terminal is arranged so as to be fixed in the electrical device and the holding element is a movable closing element in the electrical unit.

If the insertion slot also has a straight section and if a blind hole in line with the straight section branches off from the insertion slot, a cut-to-length conductor can also be clamped in a simple manner in the insulation displacement terminal device.

If the conductor has a conductor axis and if the insulation displacement terminal and the holding element execute a relative movement in a plane containing the conductor axis moving it from the open to the closed position, this results in a particularly simple design configuration of the electrical unit.

In principle, there can be any number of insulation displacement terminal devices. As a rule, however, the electrical device will have several insulation displacement terminal devices, which are arranged next to one another and/or opposite one another.

One electrical device with a mounting device, which requires several insulation displacement terminal devices, is, for example, an electromagnetic switching device, in particular a contactor.

Further advantages and details can be seen from the following description of an exemplary embodiment. Here, in principle,

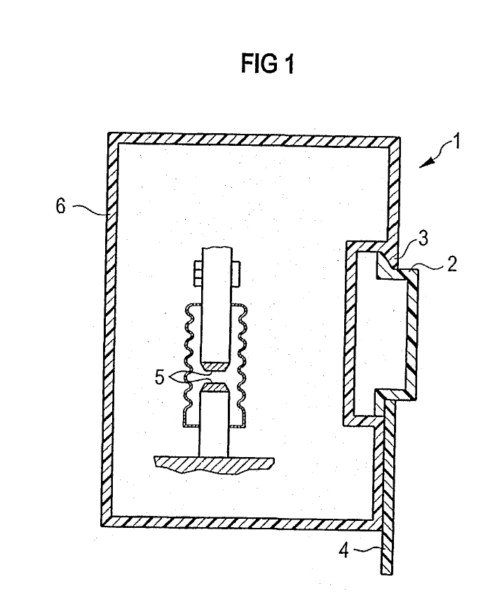

FIG. 1 shows a mounted electrical device from the side,

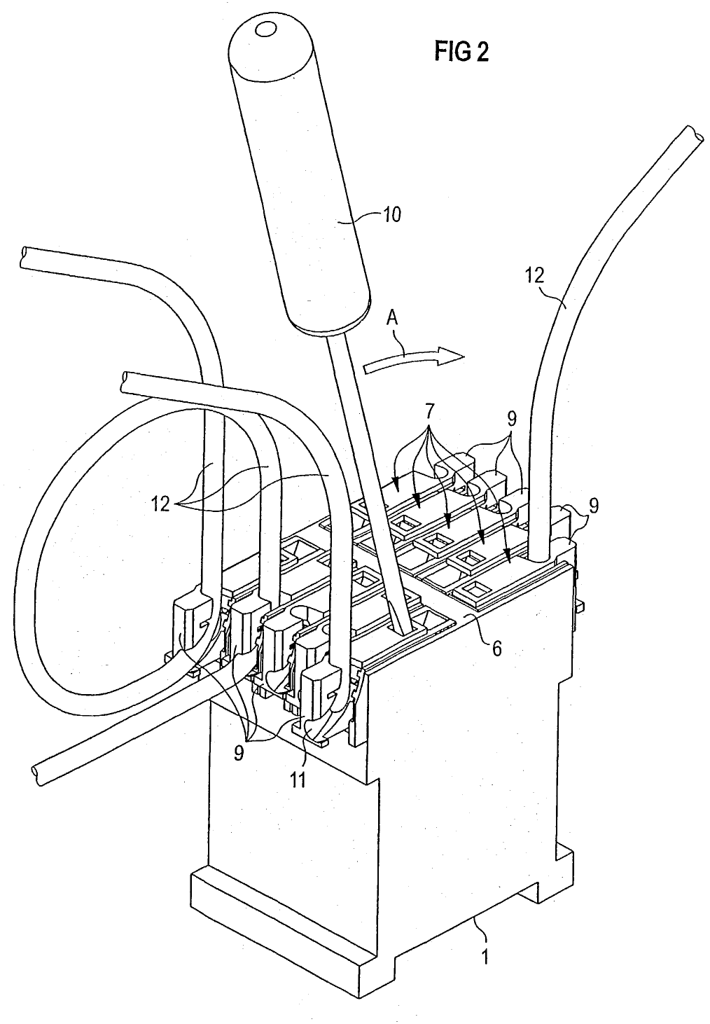

FIG. 2 shows the electrical device of FIG. 1 in perspective,

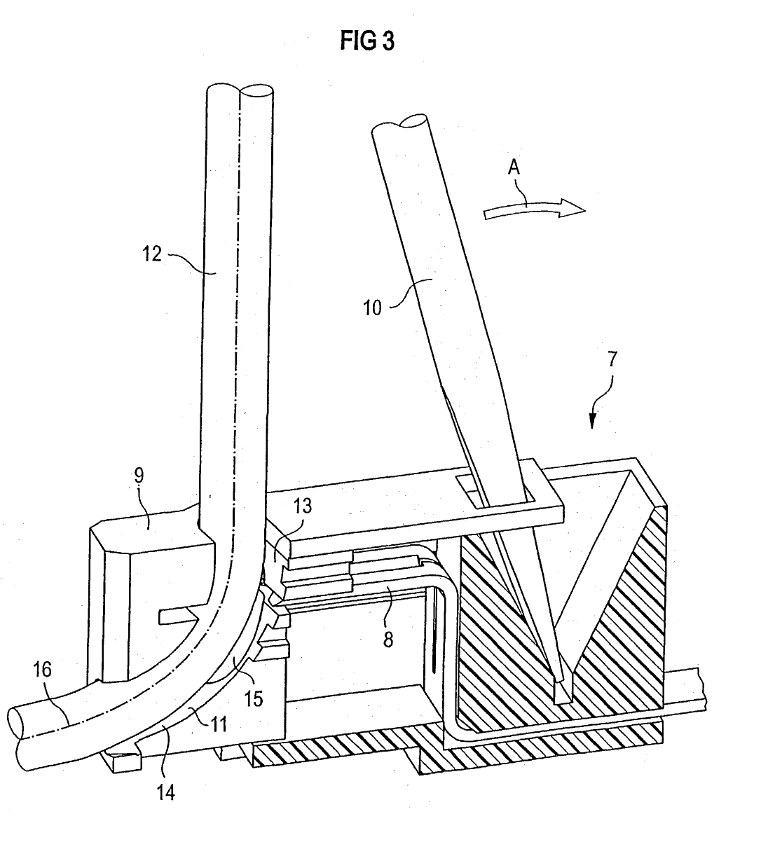

FIG. 3 shows an insulation displacement terminal device and

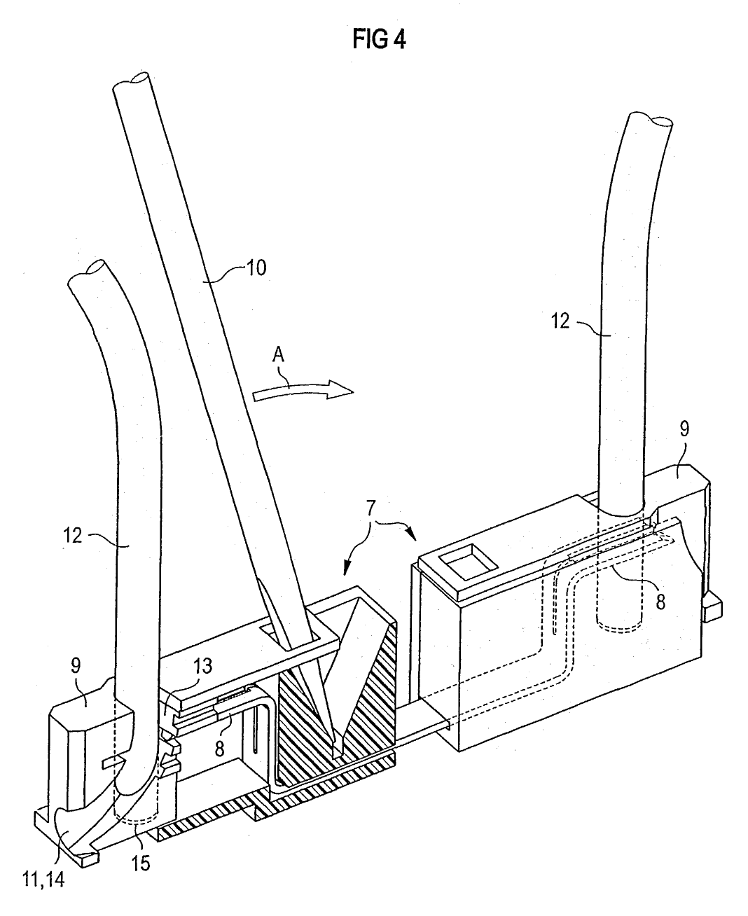

FIG. 4 shows a pair of insulation displacement terminal devices.

According to FIG. 1, a mounting face 1 of an electrical device can be fastened by means of a mounting device 1 to a supporting element 2. According to FIG. 1, the supporting element 2 is a mounting rail. The mounting device includes a hook element 3 and a spring-loaded bolt 4 so that the electrical device can be snapped onto the mounting rail 2.

In principle, the electrical device can be of any nature. According to the exemplary embodiment, it is an electromagnetic switching device, e.g. as a contactor. This is indicated in FIG. 1 by a (vacuum) contact 5, shown symbolically.

According to FIG. 2, two rows of insulation displacement terminal devices 7 are arranged on a control face 6 opposite the mounting face 1. The insulation displacement terminal devices 7 are arranged next to one another within the rows, the rows themselves being arranged opposite one another. The insulation displacement terminal devices 7 are all designed to be the same as one another.

Only one of the insulation displacement terminal devices 7 is therefore described in more detail below in conjunction with FIG. 3.

According to FIG. 3, each insulation displacement terminal device 7 comprises an insulation displacement terminal 8 and a holding element 9. According to FIG. 3, the insulation displacement terminal 8 is arranged so as to be fixed in the electrical device. The holding element 9, on the other hand, is movable in the electrical device. It is therefore a movable closing element 9. In principle, however, the holding element 9 could also be fixed and the insulation displacement terminal 8 could be movable.

The closing element 9 is movable in relation to the insulation displacement terminal 8 between an open position and a closed position. The open position is shown in FIG. 3. By pivoting a suitable operating tool 10, according to the exemplary embodiment a screwdriver 10, in the direction of an arrow A, the closing element 9 can be moved to the closed position. By pivoting the operating tool 10 back, the closing element 9 can be moved back to the open position.

Due to the arrangement of the insulation displacement terminal devices 7 on the control face 6, it is also possible to move the closing element 9 from the open position to the closed position and back again when an electrical device is fastened to the supporting element 2.

The closing element 9 has a laterally open, continuous insertion slot 11 for a conductor 12. When the closing element 9 is in the open position, the conductor 12 can be inserted in the insertion slot 11. The conductor 12 is then clamped by moving it to the closed position.

As a rule, a single-core conductor 12 (solid or stranded) is inserted into the closing element 9. However, two conductors 12 can also be inserted into the closing element 9.

Due to the characteristic that the insertion slot 11 is continuous, the conductor 12 can be looped through the closing element 9. It is also possible, on the one hand, to connect the conductor 12 to the electrical device and, on the other hand, to route the conductor 12 further to another connection. In this case, it is not necessary to cut the conductor 12 to length.

The insertion slot 11 has a straight section 13 and a curved section 14. As a result of this, a compact design of the electrical device can be achieved in spite of the capability of the conductor 12 to be looped through. Further, a blind hole 15, which is in line with the straight section 13, branches off from the insertion slot 11. It is therefore also possible, in a simple and reliable manner, to insert the cut-to-length conductor 12 into the straight section 13 and from there further into the blind hole 15 and thus to connect the conductor 12 to the electrical device without looping it further to an additional device.

The conductor 12 has a conductor axis 16 shown dotted in FIG. 3. The conductor axis 16 defines—namely in the case of straight routing of the conductor 12—at least one axis and, in the case of curved routing of the conductor 12, even defines a plane. The closing element 9 is likewise moved in a plane during the movement from the open to the closed plane. According to FIG. 3, the plane of movement of the closing element 9 and the plane defined by the conductor axis 16 coincide. However, the plane of movement contains at least the conductor axis 16.

FIG. 4 shows two of the mutually opposing insulation displacement terminal devices 7 according to FIG. 2. With the double insulation displacement terminal device so formed, the two insulation displacement terminals 8 are connect directly together. A direct connection of this kind is practical, for example, for further connection of a ground potential in the case of contactors or other electromagnetic switching devices. Direct through-connection of this kind is also practical in the case of terminal strips.

According to FIG. 4, cut-to-length conductors 12 are inserted in the straight sections 13 of the insertion slots 11 and into the blind holes 15 in the two insulation displacement terminal devices 7. According to FIG. 4, only one electrical connection is therefore made from the one conductor 12 to the other conductor 12. In principle, however, it is also possible to loop through one or even both conductors 12 without cutting to length. It is therefore possible, for example, to feed one conductor to the left-hand of the two insulation displacement terminal devices 7 shown in FIG. 4 and from there further to an additional device and, at the same time, to create two feeds from the right-hand of the two insulation displacement terminal devices 7 shown in FIG. 4 with the two strands of the right-hand conductor 12 to additional devices.

A large number of advantages can be achieved with the electrical device according to the invention. In this way, for example, only one termination point is required for making point-to-point connections. There is no need for any extra terminals for subsequent connection. It is also unnecessary to cut the looped-through conductor 12 to length. Furthermore, there is no voltage drop in the looped-through conductor due to contact resistances.

1. Electrical device with a mounting device (3, 4) for fastening the device to a supporting element (2), e.g. to a mounting rail (2), and at least one insulation displacement terminal device (7) with an insulation displacement terminal (8) and a holding element (9),
the insulation displacement terminal (8) and the holding element (9) being able to move in relation to one another,
it being possible, when the device is fastened to the supporting element (2), to insert a conductor (12) into the holding element (9) in a relative open position of insulation displacement terminal (8) and holding element (9) and to clamp it by moving it to a closed position,
the holding element (9) being designed in such a way that the conductor (12) can be looped through the holding element (9),
the holding element (9) having a laterally open, continuous insertion slot (11) for the conductor (12) and
the insertion slot (11) having a curved section (14).

2. Electrical device as claimed in claim 1, characterized in that the insulation displacement terminal (8) is arranged so as to be fixed in the electrical device and in that the holding element (9) is a movable closing element (9) in the electrical unit.

3. Electrical device as claimed in claim 1 or 2, characterized in that the insertion slot (11) also has a straight section (13).

4. Electrical device as claimed in claim 3, characterized in that a blind hole (15) in line with the straight section (13) branches off from the insertion slot (11).

5. Electrical device as claimed in one of the preceding claims, characterized in that the conductor (12) has a conductor axis (16) and in that the insulation displacement terminal (8) and the holding element (9) execute a relative movement in a plane containing the conductor axis (16) when moving it from the open into the closed position.

6. Electrical device as claimed in one of the preceding claims, characterized in that said device has at least one further insulation displacement terminal device (7).

7. Electrical device as claimed in claim 6, characterized in that the insulation displacement terminal devices (7) are arranged next to one another.

8. Electrical device as claimed in claim 6 or 7, characterized in that the insulation displacement terminal devices (7) are arranged opposite one another.

9. Electrical device as claimed in one of the preceding claims, characterized in that said device is an electromagnetic switching device, in particular as a contactor.
